(19) United States
(12) Patent Application Publication
(10) Pub. No.: US 2009/0030606 A1
(43) Pub. Date: Jan. 29, 2009

(54) Navigation System, Method and Computer Program Product for the Operation of said Navigation System

(76) Inventors: Martin Pfeifle, Seewald (DE); Volker Sasse, Lappersdorf (DE); Uwe Tantz, Nittendorf (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/162,951

(22) PCT Filed: Jan. 5, 2007
(86) PCT No.: PCT/EP2007/050108

§ 371 Date: Oct. 10, 2008

(30) Foreign Application Priority Data
Jan. 31, 2006 (DE) 10 2006 004 693.5

(51) Int. Cl. G01C 21/32

(52) U.S. Cl. 701/209

(57) ABSTRACT

Presented is a navigation system that includes a navigation apparatus, a relational database that stores navigation data as individual data records. Each individual record includes at least one respective data packet that represents a dedicated propriety database, at least one respective property of the relevant data packet, and a respective unique identifier of each of the individual data records. The navigation system further includes a database management system that is configured to access the navigation data stored in the relational database. Also presented is a method for operating the navigation system that includes using the database management system to access the navigation data in the relational database in response to an instruction from the navigation apparatus, and using, by the navigation apparatus, at least one prescribed access function to access data in the data packet that represents the dedicated propriety database.

The invention relates to a navigation system which comprises a navigation apparatus. The invention also relates to a method for the operation of said navigation system. The invention also relates to a computer program product.

EP 0 766 811 B1 discloses a route guidance system. The route guidance system has a base unit which is designed to work out a route on the basis of a route request. In addition, the route guidance system has a first database which contains map information. The route guidance system also has a communication link and a remote unit which is designed such that it transmits a route request to the base unit electromagnetically using the communication link and that it receives a route from the base unit using the communication link in response to the route request. The remote unit has a second database which contains map information. The remote unit is designed such that it compares the received route with the map information contained in the second database. If the route is not covered sufficiently by the second database, it is transmitted to the base unit electromagnetically using the communication link in order to provide map information from the first database.

It is an object of the invention to provide a navigation system and a method for operating said navigation system which allows rapid access to a large volume of navigation data and which allows the navigation data to be updated easily.

The problem is solved by the features of the independent claims. Advantageous refinements of the invention are specified in the subclaims.

In respect of a first aspect of the invention, the invention is distinguished by a navigation system which comprises a navigation apparatus, a relational database and a database management system. The navigation system is designed to access navigation data which are stored in the relational database as individual data records. The data records comprise at least one respective data packet, at least one respective property of the relevant data packet and a respective unique identifier of the relevant data record.

This allows the extensive capabilities of the relational database and/or of the database management system to be used for navigation and/or for updating navigation data which are stored in the relational database. In addition, it allows the advantages of the relational database to be combined with the advantages of a proprietary database. In particular, it allows a large volume of navigation data to be accessed sufficiently quickly using the navigation apparatus despite the use of the relational database. In this case, the data in the data packet are connected in terms of their content and/or in terms of their physical arrangement on the storage medium.

In respect of a second aspect of the invention, the invention is distinguished by a method for operating the navigation system. The database management system is used to access the navigation data in the relational database on the basis of an instruction from the navigation apparatus in order to operate the navigation system.

In one advantageous refinement of the second aspect of the invention, the data packet is compressed and then stored. This contributes to efficient use of the data packet.

In another advantageous refinement of the second aspect of the invention, the data packet contains names and/or geographical and/or graphical data. This contributes to efficient use of the navigation data.

In another advantageous refinement of the second aspect of the invention, the navigation apparatus uses at least one prescribed access function to access data in the data packet. This allows efficient evaluation and changing and hence also updating of the data in the data packet.

In another advantageous refinement of the second aspect of the invention, the prescribed access function is transferred to the database management system for the purpose of accessing the data in the data packet. This relieves the load on a navigation apparatus and can contribute to increasing the efficiency of the navigation system.

In another advantageous refinement of the second aspect of the invention, the access function is used to change the data in the data packet. This allows the data packet in just one data record and/or a small volume of data in the relevant data packet to be changed without the other data records being influenced by the change. To update the navigation data, it is then merely necessary to ascertain and prescribe the relevant access function.

In another advantageous refinement of the method, the instruction to the database management system is ascertained on the basis of a type of access by the navigation apparatus to the navigation data. The relevant data record is ascertained on the basis of the instruction. The data packet in the relevant data record is evaluated for the purpose of ascertaining the navigation data. This allows simple access to the navigation data. The type of access may be representative of a query and/or of the change, particularly of the updating, of the navigation data, for example.

In another advantageous refinement of the second aspect of the invention, the data record is ascertained on the basis of a prescribed index structure. This can contribute to particularly efficient access to the navigation data.

In another advantageous refinement of the second aspect of the invention, an execution plan is created on the basis of the instruction. The relevant data record is ascertained on the basis of the execution plan. This contributes to rapid and efficient access to the data. In another advantageous refinement of the second aspect of the invention, the access operations and/or the relevant instructions and/or the execution plans are recorded randomly. In addition, the relevant instructions and/or the execution plans are stored if the access operations and/or the relevant instructions and/or the relevant execution plans occur with a prescribed frequency. This contributes to rapid and efficient access to the data.

In another advantageous refinement of the second aspect of the invention, the data records are accessed using SQL. This allows the extensive capabilities of SQL to be used for navigation and/or for changing the navigation data. In addition, it allows the same database systems, which understand SQL, to be used for different navigation apparatuses.

In respect of a third aspect of the invention, the invention is distinguished by a computer program product. The computer program product comprises a computer-readable medium having program instructions. The program instructions can be executed by a computer. In addition, the program instructions are designed for the operation of the navigation system by the method based on the second aspect of the invention.

The invention is explained in more detail below with reference to schematic drawings, in which:

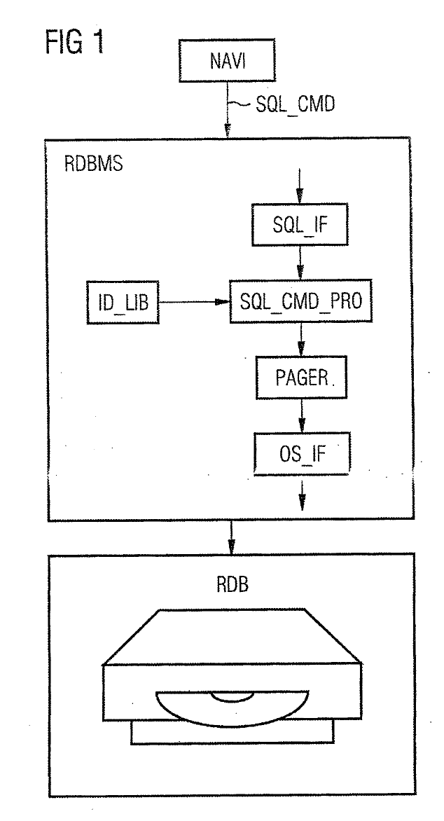

FIG. 1 shows a schematic illustration of a navigation system,

FIG. 2 shows a program for the operation of the navigation system,

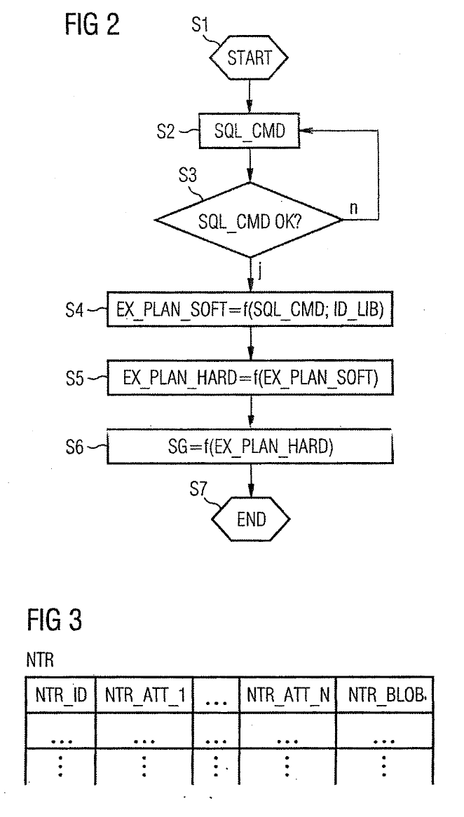

FIG. 3 shows a general table structure,

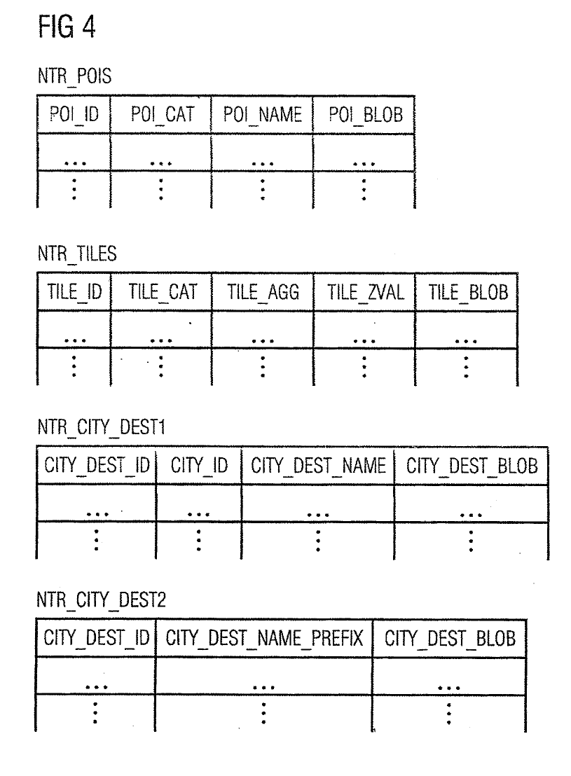

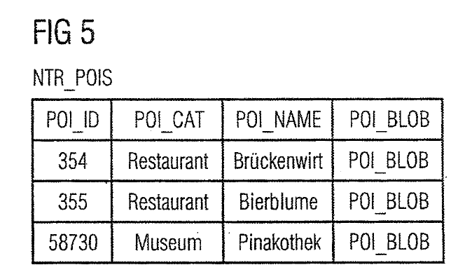

FIG. 4 shows five exemplary embodiments of the table structure, and

FIG. 5 shows a table with one of the table structures and three data records.

Elements having the same design or function are identified throughout the figures by the same reference symbols.

A navigation system (FIG. 1) comprises a navigation apparatus NAVI, a database management system RDBMS and a relational database RDB. The navigation system is used for ascertaining a route and/or for calculating a distance and/or for finding a location and/or for ascertaining other information.

The navigation apparatus NAVI may be a technical appliance which is arranged in a motor vehicle, for example. Alternatively, the navigation apparatus NAVI may also be a software product which is used by the technical appliance. By way of example, the technical appliance may be an onboard computer in a motor vehicle and/or a computer, for example a portable computer. The portable computer may be a computer in pocket format and/or a laptop, for example. The navigation apparatus NAVI and the technical appliance which comprises the navigation apparatus NAVI have input units and output units. The input units are used for inputting information, for example a route which needs to be ascertained and/or a destination, and/or information which is taken as a basis for changing, particularly updating, navigation data.

The navigation apparatus NAVI communicates with the database management system RDBMS. The database management system RDBMS comprises an SQL interface SQL_IF, an SQL command processor SQL_CMD_PRO, a pager PAGER, a directory ID_LIB of index structures and an operating system interface OS_IF.

The database management system RDBMS communicates with the relational database RDB. The relational database RDB stores the navigation data.

The navigation apparatus NAVI communicates with the database management system RDBMS preferably such that the navigation apparatus NAVI sends an instruction SQL_CMD to the database management system RDBMS. Alternatively, the instruction SQL_CMD can also be represented by suitable signals which are then translated into the relevant instruction SQL_CMD in the database management system RDBMS.

The SQL interface SQL_IF is used to check whether the instruction SQL_CMD is syntactically correct. If the instruction SQL_CMD is syntactically correct, it is transferred from the SQL interface SQL_IF to the SQL command processor SQL_CMD_PRO.

The SQL command processor SQL_CMD_PRO takes the instruction SQL_CMD and preferably at least one available index structure, which is stored in the directory ID_LIB of the index structures, as a basis for ascertaining a software execution plan EX_PLAN_SOFT. The software execution plan EX_PLAN_SOFT is a program section which is used to make the access to the navigation data as efficient as possible.

The software execution plan EX_PLAN_SOFT is transferred from the SQL command processor SQL_CMD_PRO to the pager PAGER. The pager PAGER is used to take the software execution plan EX_PLAN_SOFT as a basis for ascertaining a hardware execution plan EX_PLAN_HARD. The hardware execution plan EX_PLAN_HARD is representative of how a piece of hardware, for example a CD-ROM drive and/or a hard disk and/or other data storage media, which may comprise the relational database RDB, needs to be actuated in order to execute the software execution plan EX_PLAN_SOFT.

The hardware execution plan EX_PLAN_HARD is transferred to the operating system interface OS_IF, which translates the hardware execution plan EX_PLAN_HARD into relevant control signals for the technical appliance on which the navigation data are stored and/or which comprises the storage medium on which the navigation data are stored.

A program for operating the navigation system is preferably stored on a storage medium in the navigation system. The program is preferably started when the navigation system starts in a step S1, in which variables are possibly initialized.

In a step S2, the instruction SQL_CMD is ascertained. By way of example, the instruction SQL_CMD is ascertained on the basis of a route to be determined and/or on the basis of a prescribed destination and/or for the purpose of updating the navigation data and/or for the purpose of allowing further access operations by the navigation apparatus NAVI to the relational database RDB.

In a step S3, a check is performed to determine whether the instruction SQL_CMD is in order OK. If the condition in step S3 is not met, the processing is continued again in step S2. If the condition in S3 is met, the processing is continued in step S4.

In step S4, the instruction SQL_CMD and the available index structures are taken as a basis for ascertaining the software execution plan EX_PLAN_SOFT.

In a step S5, the hardware execution plan EX_PLAN_HARD is ascertained on the basis of the software execution plan EX_PLAN_SOFT.

In a step S6, the control signal for the technical appliance which comprises the relational database RDB is ascertained.

In a step S7, the program can be terminated. Preferably, however, the program is continued in step S2 and terminated only when the navigation system is switched off.

The navigation data are stored in the relational database RDB in tables NTR. The tables NTR have a general table structure and comprise the data records (FIG. 3). The general table structure has at least one unique identifier NTR_ID of the data record, at least one property NTR_ATT of a data packet NTR_BLOB and the relevant data packet NTR_BLOB, respectively. Preferably, each data record has a plurality of properties NTR_ATT_1 to NTR_ATT_N of the relevant data packet NTR_BLOB. The data in the data packet NTR_BLOB are connected in terms of their content and/or in terms of their physical arrangement on the storage medium. By way of example, the data packet NTR_BLOB may therefore be a concatenated succession of symbols, for example a binary code, within a large volume of data which represents the relational database RDB, for example. All of the data in a data record or the data without the properties NTR_ATT of the data packet are stored in the data packet NTR_BLOB. By way of example, the data packet NTR_BLOB contains names and/or graphical and/or geographical data. By way of example, the geographical data are degrees of length and/or width, and the geographical data may also be height statements, lakes, rivers and/or other geographical data. The graphical data are a logo for a company and/or typical façade of a building, for example.

The general table structure allows the use of properties, particularly advantages of the relational database RDB and of a proprietary database. The proprietary database is a database which has been developed specifically for the navigation apparatus NAVI. The navigation data are stored in the proprietary database such that the navigation data can be accessed only with the relevant navigation apparatus NAVI using appropriate propriety access functions.

By way of example, one advantage of the proprietary database is that a large volume of data can be stored with relatively little use of memory space. An advantage of the relational database RDB is that the data in the relational database RDB can be found and altered, particularly updated, easily and quickly, for example.

Every single one of the data packets NTR_BLOB represents a dedicated proprietary database. For the purpose of evaluating the data packets NTR_BLOB, the data packets NTR_BLOB can be transferred from the database management system RDBMS to the navigation apparatus NAVI. Preferably, however, the navigation apparatus NAVI ascertains the relevant access functions and transfers them to the database management system RDBMS for the purpose of evaluating the navigation data.

The access function can be used to alter the data packet. This is very advantageous particularly when updating the navigation data. If the direction of a one-way street is merely being reversed, for example, then it is merely necessary to replace the relevant data packet NTR_BLOB. Alternatively, it may be sufficient for the access function to update the data in the data packet NTR_BLOB.

If the navigation system is intended to be used to look for a prescribed location, for example, a table of points of interest NTR_POIS is preferably created with a table structure which is optimized to look for points of interest. The table NTR_POIS of points of interest comprises a location data packet POI_BLOB and, as properties of the location data packet POI_BLOB, a location identifier POI_ID and preferably a location category POI_CAT and/or a location name POI_NAME. The table of points of interest NTR_POIS is explained in more detail later with reference to FIG. 5.

The relational database RDB can also be used to find a prescribed map detail. To this end, a map table NTR_TILES is preferably created whose table structure is optimized to find the prescribed map detail. The map table NTR_TILES comprises a map data packet TILE_BLOB, a map identifier TILE_ID, preferably a map category TILE_CAT and/or a map aggregation level TILE_AGG and/or a map Z value TILE_ZVAL. By way of example, the map category TILE_CAT may be representative of whether the relevant map is optimized to determine a point of interest or to determine a prescribed route. The map aggregation level TILE_AGG may take account of a magnification factor for the relevant map, for example. By way of example, a first map aggregation level TILE_AGG may involve the whole of Germany being covered by six maps, and a second map aggregation level TILE_AGG involves the whole of Germany being covered by sixty maps. The map Z value TILE_ZVAL is preferably representative of the coordinates to which the map refers. By way of example, a first segment of the map Z value TILE_ZVAL may represent an X coordinate of a first corner of the relevant map, a second segment may represent a Y coordinate of the first corner of the map and a third and a fourth segment represent the coordinates of a second corner of the relevant map.

The table NTR with the general table structure may also be used to provide a user of the navigation system with input assistance.

By way of example, a first destination table NTR_CITY_DEST1 may have a table structure which is optimized to propose the next possible letter of the destination name to the user when inputting a letter in a destination name, for example. To this end, the first destination table NTR_CITY_DEST1 comprises a destination data packet CITY_DEST_BLOB, a destination identifier CITY_DEST_ID and preferably a city name identifier CITY_ID and/or a destination name CITY_DEST_NAME. When a suitable index structure is prescribed, it is then a simple matter to look for the next respective letter in the destination name CITY_DEST_NAME which is to be input. For this, the destination data packet CITY_DEST_BLOB could be empty. Preferably, the destination data packet CITY_DEST_BLOB contains the graphical and/or geographical data for the relevant destination, however.

Alternatively or in addition, the next letter in the destination name may be determined by virtue of the data records being arranged in a second destination table NTR_CITY_DEST2 whose table structure is optimized to proposing the next possible letter in the destination name to the user when inputting the first letter in the destination name. The second destination table NTR_CITY_DEST2 comprises the destination data packet CITY_DEST_BLOB, the destination identifier CITY_DEST_ID and preferably a destination name start CITY_DEST_NAME_PREFIX. If the destination name start CITY_DEST_NAME_PREFIX is an M, for example, then the destination data packet CITY_DEST_BLOB may store all towns with the initial letter M. The database management system RDBMS can then easily and quickly look for the destination name start CITY_DEST_NAME_PREFIX. Once the relevant destination data packet CITY_DEST_BLOB is found, it can be evaluated using the access function which has been transferred to the database management system RDBMS from the navigation apparatus NAVI. Alternatively, the destination data packet CITY_DEST_BLOB can be transferred from the database management system RDBMS to the navigation apparatus NAVI and evaluated in the navigation apparatus NAVI using the relevant access function. When the second destination table NTR_CITY_DEST2 is used, far less memory space is required than in the case of the first destination table NTR_CITY_DEST1. In addition, the relevant index structures may be in simpler form. The relevant access function needs to be in more extensive form, however.

The table NTR_POIS of points of interest (FIG. 5) comprises columns and rows. The first row contains the properties NTR_ATT which relate to the location data packet POI_BLOB. The restaurant Brückenwirt is stored under the location identifier POI_ID 354. The physical position of the restaurant Brückenwirt is stored in the relevant location data packet POI_BLOB. In addition, the table NTR_POI of points of interest contains the restaurant Bierblume with the location identifier POI_ID 355.

In addition to the geographical position, the relevant location data packet POI_BLOB also stores house specialties, for example. The location identifier POI_ID 58730 is representative of a museum, for example the Pinakothek in Munich. The geographical position and/or, by way of example, entry prices and/or opening times are stored in the relevant location data packet POI_BLOB.

The maximum size of the data packets NTR_BLOB and the number of rows and columns and also the number of tables NTR in the relational database RDB can be optimized on the basis of the navigation apparatus NAVI. In this case, the principle which applies is that the larger the data packets NTR_BLOB the smaller the required memory space can be. The smaller the data packets NTR_BLOB, the simpler the design of the relevant access functions can be.

The invention is not limited to the indicated exemplary embodiments. The navigation apparatus NAVI, the database management system RDBMS and/or the relational database RDB may be formed from individual hardware components and/or formed from individual software components and/or in the form of individual components of a single application. In addition, the method for operating the navigation system may be implemented wholly or in part in a computer program product or in a hardware product or in a combination of a computer program product and a hardware product. A computer-readable medium may comprise the computer program product with program instructions which can be executed by a computer, for the purpose of executing the inventive method. By way of example, the computer-readable medium may be a CD-ROM, a DVD, a flash memory card, a hard disk and/or another computer-readable medium, for example a storage medium within a network.

1-13. (canceled)

14. A navigation system, comprising:
a navigation apparatus (NAVI);
a relational database storing navigation data as individual data records, each of the data records comprising at least one respective data packet that represents a dedicated propriety database, at least one respective property of the relevant data packet, and a respective unique identifier of the each of the data records; and
a database management system configured to access the navigation data stored in the relational database.

15. A method for operating a navigation system as claimed in claim 14, comprising:
using the database management system to access the navigation data in the relational database in response to an instruction from the navigation apparatus; and
using, by the navigation apparatus, at least one prescribed access function to access data in the at least one data packet that represents the dedicated propriety database.

16. The method as claimed in claim 15, further comprising the step of compressing and then storing the at least one data packet.

17. The method as claimed in claim 15, wherein the at least one data packet includes at least one of names, geographical data, and graphical data.

18. The method as claimed in claim 15, wherein the step of using at least one prescribed access function includes transferring the at least one prescribed access function to the database management system to access the data in the at least one data packet.

19. The method as claimed in claim 15, wherein the step of using at least one prescribed access function includes using the at least one access function to change the data in the at least one data packet.

20. The method as claimed in claim 15, further comprising the steps of determining the instruction to the database management system based on a type of access operation by the navigation apparatus to the navigation data, using the instruction as a basis for determining the relevant data record, and evaluating the data packet in the relevant data record for the purpose of determining the navigation data.

21. The method as claimed in claim 15, further comprising the step of determining the data record based on a prescribed index structure.

22. The method as claimed in claim 20, further comprising the steps of creating an execution plan on the basis of the instruction, and determining the relevant data record based on the execution plan.

23. The method as claimed in claim 22, further comprising the steps of randomly recording at least one of the access operation, the relevant instruction, and the execution plan, and storing least one of the instruction and the execution plan if at least one of the access operation, the relevant instruction, and the execution plan occurs with a prescribed frequency.

24. The method as claimed in claim 15, wherein the data records are accessed using structured query language.

25. A computer-readable medium, tangibly embodying a program of instructions executable by a computer to perform method steps for operating a navigation system, the method steps comprising:
accessing, by a database management system, navigation data in a relational database in response to an instruction from a navigation apparatus; and
using, by the navigation apparatus, at least one prescribed access function to access data in a data packet that represents a dedicated propriety database.
